(19) United States
(12) Patent Application Publication
(10) Pub. No.: US 2025/0031143 A1
(43) Pub. Date: Jan. 23, 2025

(54) TRANSMIT POWER MANAGEMENT FOR RADIOS IN A WIRELESS NETWORKING DEVICE

(71) Applicant: HEWLETT PACKARD ENTERPRISE DEVELOPMENT LP, Spring, TX (US)

(72) Inventors: Eldad Perahia, Park City, UT (US); Shubham Saloni, Colma, CA (US); Amogh Guruprasad Deshmukh, Santa Clara, CA (US)

(21) Appl. No.: 18/354,750

(22) Filed: Jul. 19, 2023

(51) Int. Cl. H04W 52/02; H04W 72/0453; H04W 72/542

(52) U.S. Cl. CPC H04W 52/0206; H04W 72/0453; H04W 72/542; H04W 84/12

(57) ABSTRACT

An example method for adjusting transmit powers of radios in a wireless networking device is presented. For the wireless networking device, a network management device may determine a difference between a first free-space path loss corresponding to a first Wireless-Fidelity (Wi-Fi) band and a second free-space path loss corresponding to a second Wi-Fi band. The network management device may then set transmit powers of a first radio dedicated to the first Wi-Fi band and a second radio dedicated to the second Wi-Fi band respectively to a first transmit power and a second transmit power based on the difference. Accordingly, the wireless networking device communicates via the first radio at the first transmit power and the second radio at the second transmit power.

### BACKGROUND

Equivalent Isotropically Radiated Power (EIRP) represents the total amount of power that a radio (e.g., an antenna) of a wireless device transmits in all directions. In particular, EIRP is a net power transmitted by an antenna after accounting for the gain that the antenna provides and losses from the antenna cable. An EIRP setting for a wireless device determines the maximum signal strength that the wireless device can transmit, which in turn determines the wireless communication range of the wireless device. Generally, the use of higher transmit powers causes increased radio frequency (RF) interferences among wireless devices, especially in dense wireless network deployments. To avoid such RF interferences among different wireless devices, regulatory authorities generally provide guidelines and control measures to limit transmit power levels at various radio frequencies. Therefore, it is useful for wireless network administrators to manage the transmit powers of the wireless devices by configuring respective EIRP settings to optimize the performance of the wireless devices while ensuring compliance with the guidelines on transmit power management.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts a block diagram of a networked system in which various of the examples presented herein may be implemented.

FIG. 2 depicts a flowchart of an example method for adjusting transmit powers of radios in a wireless networking device.

FIGS. 3A and 3B depict a flowchart of another example method for adjusting transmit powers of radios in a wireless networking device.

FIG. 4 depicts a block diagram of an example computing system.

The Figures are not exhaustive and do not limit the present disclosure to the precise form disclosed.

### DETAILED DESCRIPTION

A management entity for a wireless local area network (WLAN), for example, a WLAN controller, a central management application (e.g., hosted on a cloud), or an administrator of the WLAN generally determines an EIRP setting for a transmitting wireless device (e.g., an access point) based on a path loss between the transmitting device and a receiving wireless device. Path loss or path attenuation is generally defined as a reduction in the power density of an electromagnetic wave (e.g., an RF signal) as it propagates through space. Path loss is affected by surroundings and design limitations, including the air, buildings, and sensitivities of radios' front-end circuits. Known EIRP assignment techniques use path loss values to determine an EIRP setting for the wireless networking devices in a network.

Also, in the present state of technology, wireless networking devices such as access points may operate more than one channel on different Wireless-Fidelity (Wi-Fi) frequency bands, such as the 2.4 GHz Wi-Fi band, 5 GHz Wi-Fi band, and 6 GHz Wi-Fi band. Accordingly, with the 6 GHz Wi-Fi band being enabled for Wi-Fi, many Wi-Fi 6E capable APs are generally equipped with tri-radio supporting 2.4 GHz, 5 GHz, and 6 GHz Wi-Fi bands.

Typically, signal communications over the 6 GHz Wi-Fi band experience higher path loss due to higher frequencies compared to other existing Wi-Fi bands. In addition, there exist certain regulatory limitations on Power Spectral Density (PSD) for communications over the 6 GHz Wi-Fi band. For example, in the United States, the PSD for communications over the 6 GHz Wi-Fi band is limited to 5 decibels (dBs) per megahertz (MHz). Further, for the 6 GHz Wi-Fi band, the maximum EIRP for a given radio is defined as a function of the respective operating channel's bandwidth and the PSD. In an example configuration, the maximum EIRP for a given channel (C) in the 6 GHz Wi-Fi band may be determined using an example relationship of Equation (1).

$$EIRP = PSD + 10 Log ( {BW}_{C} ) + {A}_{Gain} + {C}_{Loss} \qquad Equation ( 1 )$$

Where, PSD represents a regulatory value of the power spectral density for the 6 GHz Wi-Fi band in decibel milliwatt (dBm) per Hertz (Hz) (e.g., 5 dBm/Hz), and BWc represents a bandwidth of an operating channel in the 6 GHz Wi-Fi band in Hz, A_{Gain} represents an antenna gain in decibel isotropic (dBi), and C_{Loss} represents cable loss in dB.

It is to be noted that, as opposed to the EIRP constraints in the 6 GHz Wi-Fi band, the EIRP planning for the 2.4 GHz and the 5 GHz Wi-Fi band is less complex due to the overall higher allowed PSD in the 2.4 GHz and 5 GHz Wi-Fi bands. Table-1 presented below shows example PSD values and the maximum allowed EIRP values for various channel bandwidths in 5 GHz and 6 GHz Wi-Fi bands. The PSD and EIRP values presented in Table-1 are for an operation of a wireless networking device in a low-power indoor (LPI) mode.

TABLE 1
EIRP comparison between the 5 GHz and 6 GHz channels

| | | Channel Bandwidths | | | | | | | | | |
|---|---|---|---|---|---|---|---|---|---|---|---|
| Band | Parameter | 20 MHz | | 40 MHz | | 80 MHz | | 160 MHz | | 320 MHz | |
| 5 GHz | EIRP | 30 decibel | | 30 | dBm | 30 | dBm | 30 | dBm | 30 | dBm |
| | | milliwatt (dBm) | | | | | | | | | |
| | PSD | 17 | dB | 14 | dB | 11 | dB | 8 | dB | 5 | dB |
| 6 GHz | EIRP | 18 | dBm | 21 | dBm | 24 | dBm | 27 | dBm | 30 | dBm |
| | PSD | 5 | dB | 5 | dB | 5 | dB | 5 | dB | 5 | dB |

As depicted in the example configuration of Table-1, the channels of higher bandwidths (e.g., the 160 MHz and 320 MHz channels) in the 6 GHz Wi-Fi band can still have comparable EIRP values to the channels of similar bandwidth in the 5 GHz Wi-Fi band. However, due to the regulatory limit on the PSD, the narrower channels (e.g., the 20 MHz, 40 MHz, and 80 MHz channels) in the 6 GHz Wi-Fi band may have to operate at smaller EIRP values in the LPI mode compared to the similar channels in the 5 GHz Wi-Fi band. As it is understood, a radio operating at a smaller EIRP may have reduced coverage compared to a radio operating at a higher EIRP. Accordingly, a radio operating at a majority of the 6 GHz channels may have limited coverage compared to the radio operating at channels in the 5 GHz Wi-Fi band.

Further, as it is apparent, a signal of higher frequency experiences higher path loss compared to a signal of a lower frequency. Accordingly, due to higher frequencies in the 6 GHz Wi-Fi band, the 6 GHz Wi-Fi signals experience higher path loss compared to the 5 GHz Wi-Fi signals, resulting in further reduction in the coverage and reduced signal strength at any given point in the network. For instance, if a 5 GHz radio is operated at the same or higher EIRP value compared to that of the 6 GHz radio, the 5 GHz radio may not only have a higher range compared to the 6 GHz radio, but also, at a similar distance, the signal strength of the than 5 GHz radio will be better due to higher path loss at the 6 GHz frequencies.

Due to lower signal strength and lesser coverage, client devices may prefer associating with a 5 GHz radio than a 6 GHz radio. In some instances, even the 6 GHz capable client device may associate with an AP over the 5 GHz radio due to the reduced received signal strength from the 6 GHz radio. As a result, these 6 GHz capable client devices may not benefit from the potential and advanced communication capabilities offered over the 6 GHz Wi-Fi band. Also, in some cases, the lower Wi-Fi bands such as the 5 GHz and 2.4 GHz may be over-populated, whereas the 6 GHz Wi-Fi band may remain underutilized irrespective of the 6 GHz Wi-Fi band offering better communication features.

To solve this issue, a network management device, in examples consistent with the teachings of this disclosure, implements an EIRP balancing technique to reduce an imbalance in the client device associations among different radios and/or to ensure that the 6 GHz capable client devices associate with a 6 GHz radio and benefit from the enhanced communication offered over the 6 GHz Wi-Fi band. In some examples, the network management device is configured to adjust the EIRPs of the 5 GHz and the 6 GHz radios such that a client device may receive signals from the 5 GHz and the 6 GHz radios at similar signal strengths, thereby creating equal chances for the client device to associate with any of the 5 GHz radio or the 6 GHz radio.

In order to achieve the transmit power balance, the network management device, in examples consistent with the teachings of this disclosure, calculates a first free-space path loss for signals communications over a first operating channel (e.g., any 5 GHz channel) in a first Wireless Fidelity (Wi-Fi) band (e.g., a 5 GHz Wi-Fi band) on a wireless networking device (e.g., an AP). The network management device also calculates a second free-space path loss for signals communications over a second operating channel (e.g., any 6 GHz channel) in a second Wi-Fi band (e.g., the 6 GHz Wi-Fi band) on the wireless networking device. The network management device then determines a difference between the first free-space path loss and the second free-space path loss, hereinafter referred to as a free-space path loss difference.

Since the 6 GHz Wi-Fi band communications incur higher path loss compared to the 5 GHz Wi-Fi band communications, the network management device may dynamically adjust transmit powers (i.e., EIRPs) of one or both of a first radio (e.g., 5 GHz radio) dedicated to the first Wi-Fi band (e.g., 5 GHz Wi-Fi band) and a second radio (e.g., 6 GHz radio) dedicated to the second Wi-Fi band (e.g., 6 GHz Wi-Fi band) of the wireless networking device based on the free-space path loss difference such that a difference in signal strengths over the first Wi-Fi band and the second Wi-Fi band at a predefined location is maintained in a predefined range. In particular, in some examples, the network management device sets transmit powers of the first radio and the second radio respectively to a first transmit power and a second transmit power based on the free-space path loss difference such that a client device present at the predefined location observes little to no difference in the strengths over the first Wi-Fi band and the second Wi-Fi band. In certain examples, the network management device sets transmit powers such that, at the predefined location, a second signal strength over the second Wi-Fi band (e.g., the 6 GHz Wi-Fi-band) is greater than or equal to a first signal strength over the first Wi-Fi band (e.g., the 5 GHz Wi-Fi band). Because the client device may see a similar or greater signal strength coming from the 6 GHz radio, the client device, if 6 GHz capable, may attempt to first connect with the wireless networking device over the 6 GHz Wi-Fi band instead of connecting to and overpopulating the 5 GHz Wi-Fi band. Also, the client device may benefit from the advanced communication features over the 6 GHz Wi-Fi band.

In some examples, to enhance the utilization of the 6 GHz Wi-Fi band, the network management device may even set the transmit power over the 6 GHz Wi-Fi band at a value that is higher than the transmit power over the 5 GHz Wi-Fi band by at least the free space path loss difference plus a power margin. This may result in stronger signal strength for the 6 GHz Wi-Fi band compared to the 5 GHz Wi-Fi band. In some examples, the first transmit power and the second transmit power may be set such that, at the predefined location, a signal strength of a 6 GHz signal is higher compared to a signal strength of a 5 GHz signal, thereby increasing chances of a 6 GHz capable client device associating with the 6 GHz radio.

Once the transmit powers are adjusted, the wireless networking device may communicate wireless signals via the first radio and the second radio at adjusted transmit powers.

Further, in some examples, the network management device may proactively steer the client devices from one radio to another radio if it detects an imbalance in the client device associations across the different radios. The client device association across the between two radios is said to be imbalanced when a difference in the number of client device associations between the first radio (e.g., 5 GHz radio) and the second radio (e.g., 6 GHz radio) exceeds a predetermined amount (which may be a customizable value). To do so, the network management device maintains a knowledge base of 6 GHz capable client devices based on client device data reported from the wireless networking device. Moreover, the network management device may obtain, periodically or on-demand, client device association data specifying client devices associated with each of the first radio and the second radio from the wireless networking device. If the network management device determines that a difference in client device distribution between the first Wi-Fi band and the second Wi-Fi band exceeds a predetermined amount, the network management device may steer one or more of the 6 GHz capable client devices from the first radio to the second radio. In some other examples, to avoid overly populating the 5 GHz or the 2.4 GHz Wi-Fi bands, the network management device may also block a new 6 GHz capable client device from associating over the 5 GHz or the 2.4 GHz Wi-Fi bands, causing the new 6 GHz capable client device to connect over the 6 GHz Wi-Fi band.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

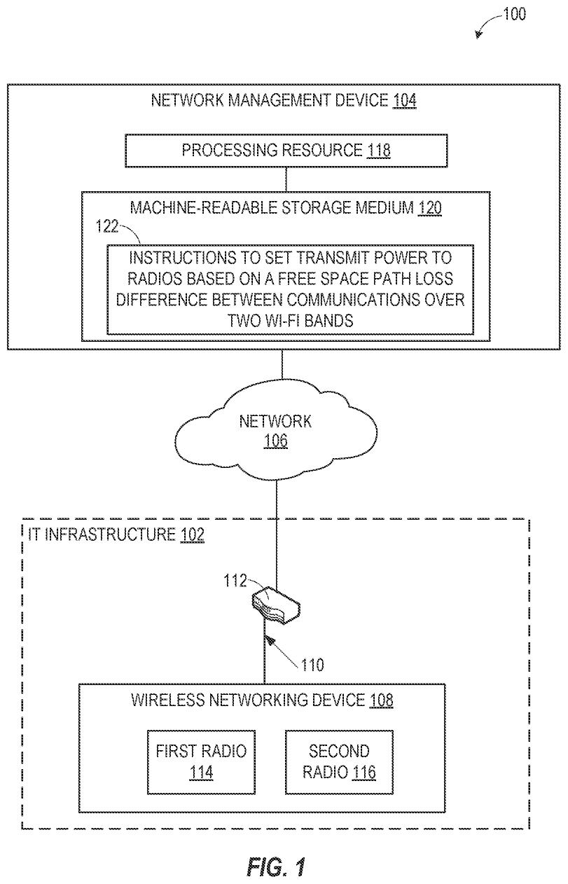

Before describing examples of the disclosed systems and methods in detail, it is useful to describe an example network installation with which these systems and methods might be implemented in various applications. FIG. 1 illustrates a networked system 100 (hereinafter referred to as system 100) in which various of the examples presented herein may be implemented. The system 100 may be implemented for any setup, for example, in a home setup or an organization, such as a business, educational institution, governmental entity, healthcare facility, or other organization. The system 100 may include an IT infrastructure 102, or both the IT infrastructure 102 and a network management device 104. In FIG. 1, although the network management device 104 is shown external to the IT infrastructure 102, in some examples, the network management device 104 may be a part of the IT infrastructure 102.

The IT infrastructure 102 may be of a small-scale network of devices or a large-scale network of devices. The small-scale network of devices may be a home network hosting a fewer number of network management devices, for example. The large-scale network of devices may be an organization, university, public utility space (e.g., mall, airport, railway station, bus station, stadium, etc.), or office network hosting a large number of network management devices, for example. The IT infrastructure 102 may span across more than one site, for example, a room, a floor of a building, a building, or any other space that can host network management devices. The IT infrastructure 102 may be a private network, such as a network that may include security and access controls to restrict access to authorized users of the private network.

The IT infrastructure 102 may include several wireless networking devices that communicate with each other and/or with any external device or system outside the IT infrastructure 102. The term wireless networking device as used herein may refer to a device capable of establishing a wireless network through which the client device (not shown) may be able to communicate with each other or any external device or system outside the IT infrastructure 102. Examples of wireless networking devices may include access points, routers, WLAN controllers, and the like. For illustration purposes, the IT infrastructure 102 of FIG. 1 is shown to include a wireless networking device 108, which may be an access point (AP), for example. Further, in some examples, the IT infrastructure 102 may optionally include a local control device such as a controller 112 communicatively coupled to the wireless networking device 108 and the network 106. It is to be noted that the examples presented herein are not limited by the specifics (e.g., types and counts) of the devices depicted in FIG. 1.

In some examples, the wireless networking device 108 and the controller 112 may be configured to communicate with other devices using wireless communication techniques specified in one or more 802.11 standard specifications published by the Institute of Electrical and Electronics Engineers (IEEE). Further, the examples of client devices that can connect to the wireless networking device 108 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like.

In some examples, the wireless networking device 108 may act as a point of access to respective local wireless networks established in IT infrastructure 102 for the client devices. The wireless networking device 108 may be a combination of hardware, software, and/or firmware that is configured to provide wireless network connectivity to client devices. The wireless networking device 108 may communicate with the client devices in accordance with one or more IEEE 802.11 standard specifications. The wireless networking device 108 radio communication circuits, such as, a first radio 114 and a second radio 116, hereinafter collectively referred to as radios 114, 116. may include a transmitter and/or a receiver to aid in data communication.

The radios 114, 116 may include electronics (e.g., signal processing circuits such as but not limited to amplifiers, modulators, demodulators, phase-shifters, signal comparators, signal conditioning circuits, etc.) useful to process the signals that are received and/or transmitted by the wireless networking device 108. In some examples, each of the radios 114, 116 may operate at one or more frequency bands that conform to one or more IEEE standards (e.g., 802.11 ax). In some examples, the first radio 114 may operate at one or more channels in a first frequency band (e.g., the 5 GHz Wi-Fi band). For instance, the first radio 114 may operate at one or more channels across the U-NII-1, U-NII-2, U-NII-3, and U-NII-4 sub-bands. Further, in some examples, the second radio 116 may operate at one or more channels in a second frequency band (e.g., the 6 GHz Wi-Fi band). For instance, the second radio 116 may operate at one or more channels across the U-NII-5, U-NII-6, U-NII-7, and U-NII-8 sub-bands. It will be understood by one skilled in the art that the radios 114, 116 may operate at any suitable frequency band and conform to any suitable type(s) of wireless communication standards, now known and later developed. In an example implementation, where the radio 114 operates on the 5 GHz Wi-Fi band and the radio 116 operates on the 6 GHz Wi-Fi band, the radio 114 and the radio 116 may be respectively also referred to as a 5 GHz radio 114 and 6 GHz radio 116. Moreover, although FIG. 1 shows wireless networking device 108 comprising two radios, it will be understood by one skilled in the art that wireless networking device 108 may comprise any suitable number of radios.

Further, although not shown, the wireless networking device 108 may include a plurality of antennas, for example, an antenna connected to each of the radios 114, 116. Such antennas, in some examples, may transmit and/or receive directional signals, omnidirectional signals, or a combination thereof. It will be understood by one skilled in the art that the antennas may comprise any suitable type(s) of antenna, now known and later developed. A net power that is radiated via an antenna associated with a given radio is hereinafter referred to as a transmit power or an EIRP associated with the given radio of the wireless networking device 108.

The wireless networking device 108 may communicate with the controller 112 over a connection 110, which may include wired and/or wireless interfaces. The controller 112 may provide communication with the network 106 for the IT infrastructure 102, though it may not be the only point of communication with the network 106 for the IT infrastructure 102. In some examples, the controller 112 may communicate with the network 106 through a router (not shown). In other implementations, the controller 112 may provide router functionality to the devices in the IT infrastructure 102. In some examples, the controller 112 may be a wireless local area network (WLAN) controller. The controller 112 may be operable to configure and manage wireless networking devices, such as at the IT infrastructure 102, and may also manage wireless networking devices at other remote sites, if any, within the IT infrastructure 102. The controller 112 may be operable to configure and/or manage switches, routers, access points, and/or client devices connected to a network. In some examples, the controller 112 may itself be, or provide the functionality of, an AP.

The network 106 may be a public or private network, such as the Internet, or another communication network to allow connectivity between the IT infrastructure 102 and the network management device 104. The network 106 may include third-party telecommunication lines, such as phone lines, broadcast coaxial cables, fiber optic cables, satellite communications, cellular communications, and the like. In some examples, the network 106 may include any number of intermediate network management devices, such as switches, routers, gateways, servers, and/or controllers, which are not directly part of the IT infrastructure 102 but that facilitate communication between the various parts of the IT infrastructure 102, and between the IT infrastructure 102 and any other network-connected entities.

The network management device 104 may be hosted on a network outside the IT infrastructure 102, for example, on a cloud platform hosted on a public, private, or hybrid cloud outside the IT infrastructure 102. In some examples, the network management device 104 may be implemented as one or more computing systems, for example, computers, controllers, servers, or storage systems. In certain examples, the network management device 104 may be an electronic device having a hardware processing resource 118, such as one or more central processing units (CPUs), semiconductor-based microprocessors, and/or other hardware devices suitable for retrieval and execution of instructions 122 stored in a machine-readable storage medium 120 (described later). In certain other examples, the network management device 104 may be implemented as a software resource, such as a software application, a virtual machine (VM), a container, a containerized application, or a pod. In some examples, the network management device 104 may be implemented as a service running on a “cloud computing” environment or as a “software as a service” (SaaS). The network management device 104 may be offered as a stand-alone product or a packaged solution that can be utilized on a one-time full product/solution purchase or pay-per-use basis.

In certain examples, not shown in FIG. 1, the network management device 104 may be deployed within the IT infrastructure 102. In such an implementation, the network management device 104 may be connected to controller 112 or any of the wireless networking device 108. In some other examples, the network management device 104 may be implemented as an AP. In an alternative implementation, the controller 112 may be configured to operate as the network management device 104.

The machine-readable storage medium 120 may be non-transitory and is alternatively referred to as a non-transitory machine-readable storage medium that does not encompass transitory propagating signals. The machine-readable storage medium 120 may be any electronic, magnetic, optical, or other type of storage device that may store data and/or executable instructions. Examples of the machine-readable storage medium 120 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 120 may be encoded with instructions 122 to adjust transmit powers of radios 114 and 116 in the wireless networking device 108. Although not shown, in some examples, the machine-readable storage medium 120 may be encoded with certain additional executable instructions to perform any other operations performed by the network management device 104, without limiting the scope of the present disclosure.

The processing resource 118 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 120, or combinations thereof. The processing resource 118 may fetch, decode, and execute the instructions 122 stored in the machine-readable storage medium 120 to manage the transmit powers of one or more wireless networking devices. In particular, the processing resource 118, by way of executing the instructions 122, may set transmit powers of the radios 114 and 114 based on free space path loss difference between communications over the Wi-Fi frequency bands (e.g., the 5 GHz Wi-Fi band and the 6 GHz Wi-Fi band).

As an alternative or in addition to executing the instructions 122, the processing resource 118 may include at least one integrated circuit (IC), control logic, electronic circuits, or combinations thereof that include several electronic components for performing the functionalities intended to be performed by the network management device 104. In some examples, when the network management device 104 is implemented as a virtual resource (e.g., a VM, a container, or a software application), the processing resource 118 and the machine-readable storage medium 120 may respectively represent a processing resource and a machine-readable storage medium of a host system hosting the network management device 104 as the virtual resource.

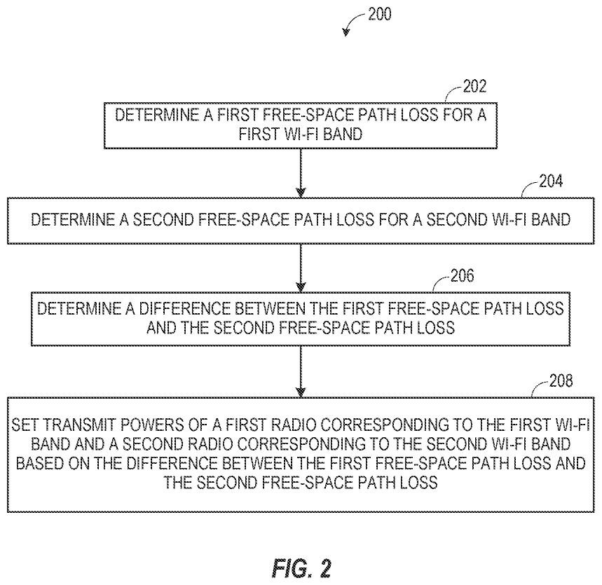

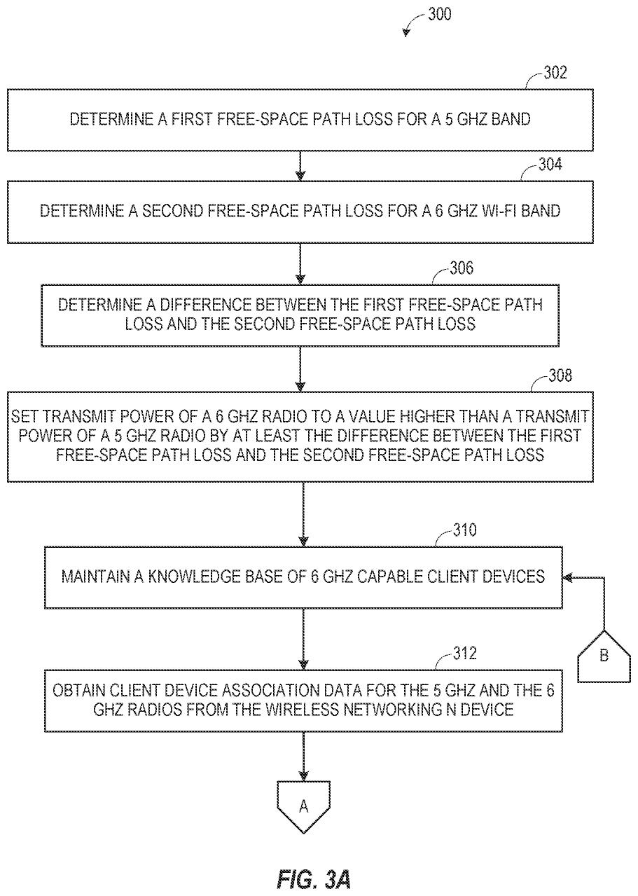

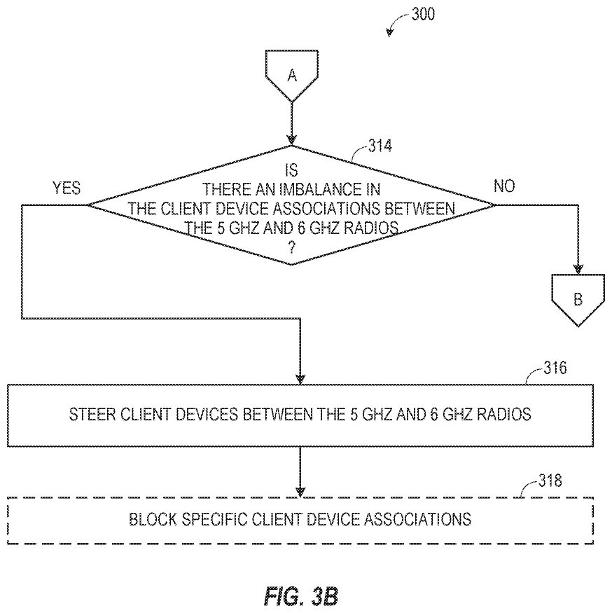

In accordance with some examples, the network management device 104 may implement, by way of the processing resource 118 executing the instructions 122, a method of adjusting transmit powers of the radios, for example, the radios 114 and 116, in the wireless networking device 108. The processing resource 118 may execute one or more of the instructions 122 to perform the method steps described in conjunction with FIGS. 2, 3A, and 3B, described later.

In examples consistent with the teachings of this disclosure, the processing resource 118 may execute the instructions 122 to implement an EIRP balancing technique thereby reducing an imbalance in the client device associations among the radios 114 and 116. This may ensure that the 6 GHz capable client devices associate with the 6 GHz radio 116 and benefit from the enhanced communication offered over the 6 GHz Wi-Fi band. In some examples, the network management device 104 is configured to adjust the EIRPs of the radios 114 and 116 such that a client device may receive signals from the 5 GHz and the 6 GHz radios at similar signal strengths, thereby creating equal chances for the client device to associate with any of the 5 GHz radio or the 6 GHz radio.

In examples consistent with the teachings of this disclosure, the network management device 104 determines a difference between the free-space path loss for the signals over the 5 GHz Wi-Fi band and the 6 GHz Wi-Fi band. Since the 6 GHz Wi-Fi band communications incur higher path loss compared to the 5 GHz Wi-Fi band communications, the network management device 104 may dynamically adjust transmit powers (i.e., EIRPs) of one or both of the radios 114 and 116 based on the free-space path loss difference such that a second signal strength over the second Wi-Fi band (e.g., the 6 GHz Wi-Fi-band) is greater than or equal to a first signal strength over the first Wi-Fi band (e.g., the 5 GHz Wi-Fi band).

In some examples, when the client device may receive similar signal strengths over both the 5 GHz Wi-Fi band and the 6 GHz Wi-Fi band, the client device, if 6 GHz capable, may attempt to first connect with the wireless networking device 108 over the 6 GHz Wi-Fi band instead of connecting to and overpopulating the 5 GHz Wi-Fi band. This way, the client device may benefit from the advanced communication features over the 6 GHz Wi-Fi band. In some examples, to enhance the utilization of the 6 GHz Wi-Fi band, the network management device 104 may even set the transmit power via the 6 GHz radio 116 at a higher value by adding a certain power margin. This may result in stronger signal strength for the 6 GHz Wi-Fi band compared to the 5 GHz Wi-Fi band. In some examples, the transmit power for radios 114 and 116 may be set such that, at the predefined location, a signal strength of a 6 GHz signal is higher compared to a signal strength of a 5 GHz signal, thereby increasing chances of a 6 GHz capable client device associating with the 6 GHz radio 116. Once the transmit powers are set, the wireless networking device may communicate wireless signals via the first radio and the second radio at the set transmit powers.

Further, in some examples, the network management device 104 may proactively manage associations of the client devices across the radios 114 and 116. For example, in the event the associations are found imbalanced, the network management device 104 may steer the client devices from one radio to another radio (e.g., from the radio 114 to the radio 116, or vice-versa). In some other examples, to avoid overly populating the 5 GHz Wi-Fi band, the network management device 104 may also block a new 6 GHz capable client device from associating over the 5 GHz Wi-Fi band, causing the new 6 GHz capable client device to connect over the 6 GHz Wi-Fi band. Additional details of dynamically adjusting the transmit powers (i.e., EIRPs) of one or both of the radios 114 and 116 and managing the associations of the client devices are described in conjunction with the methods described in FIGS. 2, 3A, and 3B.

Additionally, it is understood that the path loss difference between two channels is dependent on a separation between the two operating channels. In particular, the closer the operating channels; the lesser will be the path loss difference, and vice-versa. For example, a path difference between a channel at the beginning of the UNII-5 band (which is within the 6 GHz Wi-Fi band) and a channel at the end of the UNII-4 band (which is within the 5 GHz Wi-Fi band), may be lesser than 2 dB. Therefore, in some examples, the network management device, to reduce the path loss difference between the signals over the 5 GHz Wi-Fi band and the 6 GHz Wi-Fi band, may instruct the wireless networking device 108 to operate the radios 114 and 116 at closer operating channels to the extent such channels are available of use.

In the description hereinafter, several of the operations performed by a network management device, for example, the network management device 104, are described with the help of flowcharts shown in FIGS. 2, 3A, and 3B. In some examples, the operations described in these flowcharts may be performed by a processing resource (e.g., the processing resource 118) by executing instructions (e.g., the instructions 122) stored in the machine-readable storage medium (e.g., machine-readable storage medium 120). As an alternative or in addition to retrieving and executing instructions, the operations described in these flowcharts may be performed by implementing one or more electronic circuits that include electronic components such as an FPGA, ASIC, or other electronic circuits.

Referring now to FIG. 2, a flowchart of an example method 200 for dynamically adjusting transmit powers of radios in a wireless networking device is depicted. For the purposes of illustration of an example in FIG. 2, the wireless networking device (e.g., the wireless networking device 108 of FIG. 1) is configured to operate a first radio (e.g., the 5 GHz radio 114) at one of the available 5 GHz channels (hereinafter referred to as a first operating channel), and a second radio (e.g., 6 GHz radio 116) at one of the available 6 GHz channels (hereinafter referred to as a second operating channel).

At step 202, the network management device determines a first free-space path loss at a predefined location. The first free-space path loss is determined for a first frequency (f1) corresponding to the first operating channel in the first Wi-Fi band (e.g., 5 GHz Wi-Fi band). The network management device calculates the first free-space path loss based at least on the distance (d) between the wireless networking device and the predefined location, and the first frequency (f1). The first frequency (f1) may be the center frequency of the first operating channel. Equation (2) represented below shows an example calculation of the first free-space path loss in dBs.

$$FPL {1}_{d} = 20 {Log}_{10} ( \frac{4 π df 1}{c} ) \qquad Equation ( 2 )$$

where, c represents the speed of light.

Further, at step 204, the network management device determines a second free-space path loss at the predefined location for the second operating channel in the second Wi-Fi band (e.g., 6 GHz Wi-Fi band). The network management device calculates the second free-space path loss (FPL2_{d}) based at least on the distance (d) between the wireless networking device and the predefined location, and a second frequency (f2) of transmitted signals from the wireless networking device. The second frequency (f2) may be the center frequency of the second operating channel. Equation (3) represented below shows an example calculation of the second free-space path loss in dBs.

$$FPL {2}_{d} = 20 {Log}_{10} ( \frac{4 π {df}^{2}}{c} ) \qquad Equation ( 3 )$$

Further, at step 206, the network management device determines a difference (DIFF_{PL}), hereinafter also referred to as a free-space path loss difference, between the first free-space path loss (FPL1_{d}) and the second free-space path loss (FPL2_{d}). Equation (4) represented below shows an example calculation of an absolute difference (DIFF_{PL}) between the first free-space path loss (FPL1_{d}) and the second free-space path loss (FPL2_{d}).

$${DIFF}_{PL} = \vert FPL {1}_{d} - FPL {2}_{d} \vert \qquad Equation ( 4 )$$

At step 208, the network management device sets a transmit power (i.e., EIRP) of the first radio to a first transmit power (TXₛₑₜ₁) and the second radio to a second transmit power (TXₛₑₜ₂) based on the free-space path loss difference such that, at a predefined location, a second signal strength (RSS2, described later) over the second Wi-Fi band is greater than or equal to a first signal strength (RSS1, described later) over the first Wi-Fi band. The first signal strength (RSS1) and the second signal strength (RSS2) are also referred to as a 5 GHz signal strength and 5 GHz signal strength, respectively. Setting the transmit powers of the radios may include calculating the first transmit power and the second transmit power, and instructing the wireless networking device to adjust the transmit powers of the first radio and the second radio to the first transmit power and the second transmit power, respectively.

Chances for a 6 GHz capable client device, located at the distance (d), associating over the 6 GHz Wi-Fi band may increase if the 6 GHz capable client device observes similar signal strengths for both the 5 GHz Wi-Fi band and the 6 GHz Wi-Fi band or in cases where higher signal strength is observed over 6 GHz Wi-Fi band compared to the 5 GHz Wi-Fi band. In one example, for a client device to observe the similar signal strengths for both the 5 GHz Wi-Fi band and the 6 GHz Wi-Fi band, the network management device sets the transmit powers TXₛₑₜ₁ and TXₛₑₜ₂ such that any additional free-space path loss incurred to the 6 GHz signal may be compensated by the increased TXₛₑₜ₂. In particular, the network management device may calculate the second transmit power (TXₛₑₜ₂) by adding the free-space path loss difference (DIFF_{PL}) to the first transmit power (TXₛₑₜ₁) as represented by example Equation (5).

$${TX}_{set 2} = {TX}_{set 1} + {DIFF}_{PL} \qquad Equation ( 5 )$$

By operating the 6 GHz radio at the second transmit power (TXₛₑₜ₂) as shown in Equation (5), the 6 GHz capable client device may observe similar signal strengths for both the 5 GHz signals and the 6 GHz signals. For example, the first signal strength or the 5 GHz signal strength (RSS1) for a signal transmitted over the first operating channel may be determined as a difference between the first transmit power of the first radio (e.g., TXₛₑₜ₁) and the first free-space path loss (FPL1_{d}), represented via the example relationship of Equation (6).

$$RSS 1 = {TX}_{set 1} - FPL {1}_{d} \qquad Equation ( 6 )$$

Similarly, the network management device may calculate a second signal strength (RSS2) or the 6 GHz signal strength for a signal transmitted over the second operating channel as a difference between the second transmit power of the second radio (e.g., TX_{Set2}) and the second free-space path loss (FPL2_{d}), represented via the example relationship of Equation (7).

$$RSS 2 = {TX}_{set 2} - FPL {2}_{d} \qquad Equation ( 7 )$$

The signal strengths RSS1 and RSS2 calculated hereinabove may be theoretical values without accounting for a receiver sensitivity, antenna gain, and cable losses considering a given receiving device (e.g., client device) located at the predefined location may exhibit and/or experience similar receiver sensitivity, antenna gain, and cable loss over both the 5 GHz and 6 GHz Wi-Fi bands. In some examples, the network management device may also consider the receiver sensitivity of a given receiving device (e.g., a client device) in determining the signal strengths. In some examples, the values of the signal strengths may as well be reported by the receiving device to the network management device.

In some examples, the network management device selects the first transmit power (TXₛₑₜ₁) of the first radio and the second transmit power (TXₛₑₜ₂) of the second radio such that the second signal strength (RSS2) is equal to or greater than the first signal strength (RSS1). In one example, the signal strengths over the 5 GHz and 6 GHz Wi-Fi bands may be similar (e.g., RSS2=RSS1) when the second transmit power (TXₛₑₜ₂) is set to first transmit power (TXₛₑₜ₁) plus the free-space path loss difference (DIFF_{PL}). Due to the similar signal strengths observed for both the 5 GHz signals and the 6 GHz signals, the 6 GHz client device may attempt to connect with the wireless networking device over the 6 GHz Wi-Fi band instead of connecting to and overpopulating the 5 GHz Wi-Fi band.

Further, in some examples, to promote the utilization of the 6 GHz Wi-Fi band, the network management device may even set the transmit powers TXₛₑₜ₁ and TXₛₑₜ₂ such that, at the given location, the 6 GHz signal strength is higher compared to the 5 GHz signal strength (i.e., RSS2>RSS1). In particular, in this configuration, the network management device may set the second transmit power (TXₛₑₜ₂) to a value higher than the first transmit power (TXₛₑₜ₁) by free-space path loss difference (DIFF_{PL}) plus a power margin (P_{MARGIN}) as represented in the example relationship of Equation (8).

$${TX}_{set 2} = {TX}_{set 1} + {DIFF}_{PL} + {P}_{MARGIN} \qquad Equation ( 8 )$$

The power margin (P_{MARGIN}) may be a customizable value. Setting the power margin (P_{MARGIN}) to a value greater than zero may cause the 6 GHz Wi-Fi signals to have a stronger signal strength than the 5 GHz Wi-Fi signals at the distance (d). In particular, when the second transmit power (TXₛₑₜ₂) is set to a value calculated using Equation (8), the signal strengths over the 6 GHz Wi-Fi band may be higher than the signal strength over the 5 GHz Wi-Fi band by at least the power margin (e.g., RSS2=RSS1+P_{MARGIN}). In particular, with such added power margin, the 6 GHz capable client device may observe higher signal strength over the 6 GHz Wi-Fi band compared to the 5 GHz Wi-Fi band. This may increase the chances of a 6 GHz capable client device associating with the 6 GHz radio.

The transmit power for the 6 GHz Wi-Fi band is limited by PSD limits (e.g., 5 dBs per MHz in the US). Therefore, in some examples, to limit the second transmit power (TXₛₑₜ₂) within the prescribed PSD limits, the network management device may be configured to reduce the first transmit power (TXₛₑₜ₁).

Once the transmit powers TXₛₑₜ₁, TXₛₑₜ₂ are calculated, the network management device transmits a power management instruction to the wireless networking device to cause the wireless networking device to operate the first radio and the second radio at the transmit powers TXₛₑₜ₁, TXₛₑₜ₂, respectively. In particular, the power management instruction may include an EIRP setting representing the transmit powers TXₛₑₜ₁, TXₛₑₜ₂. Upon receiving the power management instruction, the wireless networking device may adjust the transmit power of the first radio and the second radio respectively to match the transmit powers TXₛₑₜ₁, TXₛₑₜ₂. In some other examples, the power management instruction may include a command to increase or decrease the transmit powers of the first radio and the second radio. Once the transmit powers are adjusted, the wireless networking device may communicate wireless signals via the first radio and the second radio at adjusted transmit powers TXₛₑₜ₁, TXₛₑₜ₂, respectively.

Referring now to FIGS. 3A and 3B, a flowchart of an example method 300 for dynamically adjusting transmit powers of radios in a wireless networking device is depicted. For the sake of brevity, certain details of operations (e.g., operations described in steps 302-308) that are described in any of the previous drawings are not repeated herein.

At step 302, the network management device determines a first free-space path loss at a predefined location. The first free-space path loss is determined for a first frequency corresponding to the first operating channel in the first Wi-Fi band (e.g., 5 GHz Wi-Fi band) based on the distance (d) between the wireless networking device and the predefined location, and a first frequency (f1) of the first operating channel. Further, at step 304, the network management device determines a second free-space path loss at the predefined location for the second operating channel in the second Wi-Fi band (e.g., 6 GHz Wi-Fi band). The network management device calculates the second free-space path loss based at least on the distance (d) between the wireless networking device and the predefined location, and a second frequency (f2) of the second operating channel.

Further, at step 306, the network management device determines a difference, hereinafter also referred to as a free-space path loss difference, between the first free-space path loss and the second free-space path loss. Furthermore, at step 308, the network management device sets a transmit power (i.e., EIRP) of the first radio to a first transmit power and the second radio to a second transmit power based on the free-space path loss difference such that a second signal strength over the second Wi-Fi band (e.g., the 6 GHz Wi-Fi-band) is greater than or equal to a first signal strength over the first Wi-Fi band (e.g., the 5 GHz Wi-Fi band). In particular, in one example, as the client device located at the predefined location may see the same signal strength coming from both the 5 GHz radio and the 6 GHz radio, the client device, if 6 GHz capable, may attempt to first connect with the wireless networking device over the 6 GHz Wi-Fi band instead of connecting to and overpopulating the 5 GHz Wi-Fi band. In some examples, to promote the utilization of the 6 GHz Wi-Fi band, the network management device may even set the second transmit power at a value higher than the transmit power by at least the free space path loss difference resulting in stronger signal strength for the 6 GHz Wi-Fi band compared to the 5 GHz Wi-Fi band. This may increase the chances of the 6 GHz capable client devices connecting to the wireless networking device over the 6 GHz Wi-Fi band than connecting over the 5 GHz Wi-Fi band.

Once the transmit powers are adjusted, the wireless networking device may communicate with the client devices via the first radio and the second radio at adjusted transmit powers, respectively.

Further, during the operation of the network management device, at step 310, the network management device maintains (e.g., creates and/or updates) a knowledge base of 6 GHz capable client devices based on client device data reported from the wireless networking device. The wireless networking device may be configured to send, periodically or on request from the network management device, information (e.g., device type, device identifier (e.g., a media access control address), etc.) about the 6 GHz capable client devices that have been associated with the wireless networking device. The knowledge base may store such information reported by the wireless networking device. The network management device may also update the knowledge base periodically or upon receiving the client device data from the wireless networking device.

Moreover, at step 312, the network management device may obtain a client device association data from the wireless networking device. The client device association data may include information about client devices associated with each of the first radio (e.g., the 5 GHz radio) operating on the first Wi-Fi band (e.g., the 5 GHz Wi-Fi band) and the second radio (e.g., the 6 GHz radio) of the second Wi-Fi band (e.g., the 5 GHz Wi-Fi band). With the receipt of the client device association data, the network management device may determine how many devices each radio is serving.

At step 314, the network management device may perform a check to determine, based on the client device association data, whether there is an imbalance in the client device association between the first radio and the second radio. The client device association across the between two radios is said to be imbalanced when a difference in the number of client device associations between the first radio (e.g., 5 GHz radio) and the second radio (e.g., 6 GHz radio) exceeds a predetermined amount (which may be a customizable value). At step 314, if it is determined that there is no imbalance in the client device distribution between the 5 GHz radio and the 5 GHz radio, the network management device, at step 310, may continue monitoring the wireless networking device for any updates regarding the 6 GHz capable client device and maintain the knowledge base of the 6 GHz capable client devices. However, at step 314, if the network management device determines that a difference in the client device distribution between the 5 GHz radio and the 5 GHz radio exceeds the predetermined amount, the network management device, at block 316, may steer one or more of the 6 GHz capable client devices from the 5 GHz radio to the 6 GHz radio. In some examples, the steering comprises associating the 6 GHz capable client devices to the second radio in compliance with band steering techniques specified in the IEEE 802.11v Specification.

Alternatively or additionally, in some examples, at block 318, the network management device may block any new 6 GHz capable client device from associating over the 5 GHz Wi-Fi band responsive to detecting an imbalance in client device associations between the first radio and the second radio based on the client device association data. This may cause the new 6 GHz capable client devices to connect over the 6 GHz Wi-Fi band, thereby avoiding overly populating the 5 GHz or the 2.4 GHz Wi-Fi bands.

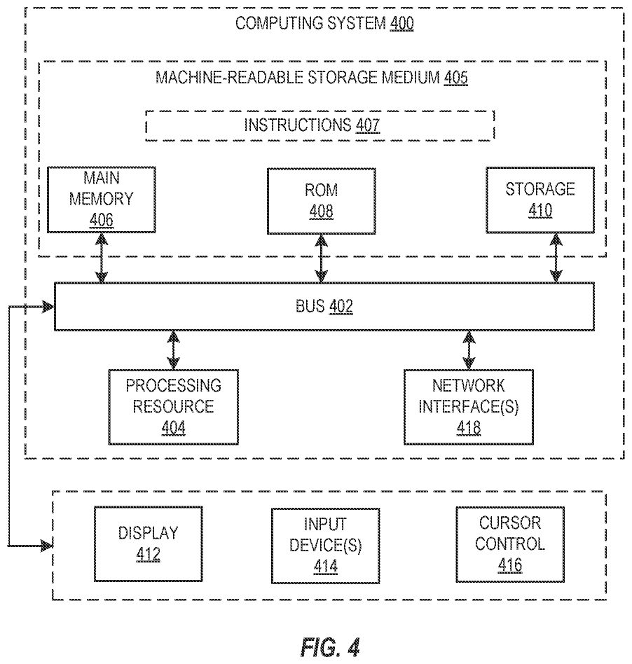

FIG. 4 depicts a block diagram of an example computing system 400 in which various of the examples described herein may be implemented. In some examples, the computing system 400 may be configured to operate as a network management device, such as the network management device 104 of FIG. 1, and can perform various operations described in conjunction with one or more of the earlier drawings. In some other examples, the computing system 400 may be configured to operate as a network management device, such as the network management device 104 of FIG. 1, and can perform various operations described in one or more of the earlier drawings. Examples of the devices and/or systems that may be implemented as the computing system 400 may include, desktop computers, laptop computers, servers, web servers, authentication servers, AAA servers, DNS servers, DHCP servers, IP servers, VPN servers, network policy servers, mainframes, tablet computers, e-readers, netbook computers, televisions and similar monitors (e.g., smart TVs), content receivers, set-top boxes, PDAs, mobile phones, smartphones, smart terminals, dumb terminals, virtual terminals, video game consoles, virtual assistants, IoT devices, and the like.

The computing system 400 may include a bus 402 or other communication mechanisms for communicating information, a hardware processor, also referred to as processing resource 404, and a machine-readable storage medium 405 coupled to the bus 402 for processing information. In some examples, the processing resource 404 may include one or more CPUs, semiconductor-based microprocessors, and/or other hardware devices suitable for retrieval and execution of instructions stored in the machine-readable storage medium 405. The processing resource 404 may fetch, decode, and execute instructions to manage the transmit powers of wireless networking devices. As an alternative or in addition to retrieving and executing instructions, the processing resource 404 may include one or more electronic circuits that include electronic components for performing the functionality of one or more instructions, such as an FPGA, an ASIC, or other electronic circuits.

In some examples, the machine-readable storage medium 405 may include a main memory 406, such as a RAM, cache and/or other dynamic storage devices, coupled to the bus 402 for storing information and instructions to be executed by the processing resource 404. The main memory 406 may also be used for storing temporary variables or other intermediate information during the execution of instructions to be executed by the processing resource 404. Such instructions, when stored in storage media accessible to the processing resource 404, render the computing system 400 into a special-purpose machine that is customized to perform the operations specified in the instructions. The machine-readable storage medium 405 may further include a read-only memory (ROM) 408 or other static storage device coupled to the bus 402 for storing static information and instructions for the processing resource 404. Further, in the machine-readable storage medium 405, a storage device 410, such as a magnetic disk, optical disk, or USB thumb drive (Flash drive), etc., may be provided and coupled to the bus 402 for storing information and instructions.

In some examples, the computing system 400 may be coupled, via the bus 402, to a display 412, such as a liquid crystal display (LCD) (or touch-sensitive screen), for displaying information to a computer user. In some examples, an input device 414, including alphanumeric and other keys (physical or software generated and displayed on a touch-sensitive screen), may be coupled to the bus 402 for communicating information and command selections to the processing resource 404. Also, in some examples, another type of user input device such as a cursor control 416 may be connected to the bus 402. The cursor control 416 may be a mouse, a trackball, or cursor direction keys. The cursor control 416 may communicate direction information and command selections to the processing resource 404 for controlling cursor movement on the display 412. In some other examples, the same direction information and command selections as cursor control may be implemented via receiving touches on a touch screen without a cursor.

In some examples, the computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 400 also includes a network interface 418 coupled to bus 402. The network interface 418 provides a two-way data communication coupling to one or more network links that are connected to one or more local networks. For example, the network interface 418 may be an integrated services digital network (ISDN) card, cable modem, satellite modem, or a modem to provide a data communication connection to a corresponding type of telephone line. As another example, the network interface 418 may be a local area network (LAN) card or a wireless communication unit (e.g., a Wi-Fi chip/module).

In some examples, the machine-readable storage medium 405 (e.g., one or more of the main memory 406, the ROM 408, or the storage device 410) stores instructions 407 which when executed by the processing resource 404 may cause the processing resource 404 to execute one or more of the methods/operations described hereinabove. The instructions 407 may be stored on any of the main memory 406, the ROM 408, or the storage device 410. In some examples, the instructions 407 may be distributed across one or more of the main memory 406, the ROM 408, or the storage device 410. In some examples, the instructions 407 may include instructions that when executed by the processing resource 404 may cause the processing resource 404 to perform one or more of the methods described in FIGS. 2, 3A, and 3B.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

What is claimed is:

1. A method comprising:
determining, by a network management device for a wireless networking device, a difference between a first free-space path loss corresponding to a first Wireless Fidelity (Wi-Fi) band and a second free-space path loss corresponding to a second Wi-Fi band, wherein the wireless networking device comprises a first radio for communicating over the first Wi-Fi band and a second radio for communicating over the second Wi-Fi band; and
setting, by the network management device, transmit powers of the first radio and the second radio respectively to a first transmit power and a second transmit power based on the difference such that, at a predefined location, a second signal strength over the second Wi-Fi band is greater than or equal to a first signal strength over the first Wi-Fi band, wherein the wireless networking device communicates via the first radio at the first transmit power and the second radio at the second transmit power.

2. The method of claim 1, further comprising determining, by the network management device, the first free-space path loss for a first operating channel in the first Wi-Fi band, and the second free-space path loss for a second operating channel in the second Wi-Fi band.

3. The method of claim 1, further comprising selecting, by the network management device, the second transmit power higher than the first transmit power at least by the difference.

4. The method of claim 1, wherein the first Wi-Fi band is the 5 GHz Wi-Fi band, and the second Wi-Fi band is the 6 GHz Wi-Fi band defined in one or more of the Institute of Electrical and Electronics Engineers (IEEE) 802.11 Specifications.

5. The method of claim 1, further comprising generating, by the network management device, a knowledge base of 6 GHz capable client devices based on client device data reported from the wireless networking device.

6. The method of claim 5, further comprising obtaining, by the network management device, a client device association data from the wireless networking device, wherein the client device association data comprises information of client devices associated with each of the first radio of the first Wi-Fi band and the second radio of the second Wi-Fi band.

7. The method of claim 6, further comprising steering, by the network management device, one or more of the 6 GHz capable client devices from the first radio to the second radio responsive to detecting an imbalance in client device associations between the first radio and the second radio based on the client device association data.

8. The method of claim 7, wherein the steering comprises associating the 6 GHz capable client devices to the second radio in compliance with band steering techniques specified in the IEEE 802.11v Specification.

9. The method of claim 6, further comprising blocking, by the network management device, a new 6 GHz capable client device from associating over the first Wi-Fi band responsive to detecting an imbalance in client device associations between the first radio and the second radio based on the client device association data.

10. The method of claim 1, wherein the first Wi-Fi band is the 2.4 GHz Wi-Fi band, and the second Wi-Fi band is the 6 GHz Wi-Fi band.

11. A network management device comprising:
a machine-readable storage medium storing program instructions; and
a processing resource executing the program instructions stored in the machine-readable storage medium to:
determine, for a wireless networking device, a difference between a first free-space path loss corresponding to a 5 GHz Wi-Fi band and a second free-space path loss corresponding to a 6 GHz Wi-Fi band, wherein the wireless networking device comprises a 5 GHz radio for communicating over the 5 GHz Wi-Fi band and a 6 GHz radio for communicating over the 6 GHz Wi-Fi band; and
set transmit powers of the 5 GHz radio and the 6 GHz radio respectively to a first transmit power and a second transmit power based on the difference such that, at a predefined location, a 6 GHz signal strength is greater than or equal to a 5 GHz signal strength, wherein the wireless networking device communicates via the 5 GHz radio at the first transmit power and the 6 GHz radio at the second transmit power.

12. The network management device of claim 11, wherein the processing resource is configured to execute one or more of the program instructions to set the second transmit power higher than the first transmit power at least by the difference.

13. The network management device of claim 11, wherein the processing resource is further configured to execute one or more of the program instructions to maintain a PSD for the 6 GHz Wi-Fi band within a predefined regulatory limit specified for the 6 GHz Wi-Fi band.

14. The network management device of claim 11, wherein the processing resource is further configured to execute one or more of the program instructions to generate a knowledge base of 6 GHz capable client devices based on client device data reported from the wireless networking device.

15. The network management device of claim 14, wherein the processing resource is further configured to execute one or more of the program instructions to obtain, from the wireless networking device, a client device association data specifying client devices associated with each of the 5 GHz radio of the 5 GHz Wi-Fi band and the 6 GHz radio of the 6 GHz Wi-Fi band.

16. The network management device of claim 15, wherein the processing resource is further configured to execute one or more of the program instructions to steer one or more of the 6 GHz capable client devices from the 5 GHz radio to the 6 GHz radio responsive to detecting, based on the client device association data, an imbalance in client device associations between the 5 GHz radio and the 6 GHz radio.

17. The network management device of claim 16, wherein the processing resource is further configured to execute one or more of the program instructions to block a new 6 GHz capable client device from associating over the 5 GHz Wi-Fi band responsive to detecting, based on the client device association data, an imbalance in client device associations between the 5 GHz radio and the 6 GHz radio.

18. A networked system comprising:
a wireless networking device comprising a 5 GHz radio for communicating over a 5 GHz Wi-Fi band and a 6 GHz radio for communicating over a 6 GHz Wi-Fi band; and
a network management device communicatively coupled to the wireless networking device, wherein the network management device is configured to:
determine, for the wireless networking device, a difference between a first free-space path loss corresponding to the 5 GHz Wi-Fi band and a second free-space path loss corresponding to the 6 GHz Wi-Fi band; and
set a transmit power of the 6 GHz radio to a value higher than a transmit power of the 5 GHz radio by at least the difference such that, at a predefined location, a 6 GHz signal strength is greater than or equal to a 5 GHz signal strength.

19. The networked system of claim 18, wherein the network management device is further configured to:
generate a knowledge base of 6 GHz capable client devices based on client device data reported from the wireless networking device; and
obtain, from the wireless networking device, a client device association data specifying client devices associated with each of the 5 GHz radio of the 5 GHz Wi-Fi band and the 6 GHz radio of the 6 GHz Wi-Fi band.

20. The networked system of claim 19, wherein the network management device is further configured to:
responsive to detecting, based on the client device association data, an imbalance in client device associations between the 5 GHz radio and the 6 GHz radio:
steer one or more of the 6 GHz capable client devices from the 5 GHz radio to the 6 GHz radio; or
block a new 6 GHz capable client device from associating over the 5 GHz Wi-Fi band or a 2.4 GHz Wi-Fi band.
